(19) United States
(12) Patent Application Publication
(10) Pub. No.: US 2009/0324901 A1
(43) Pub. Date: Dec. 31, 2009

(54) INTERIOR MATERIAL ARTICLE FOR AUTOMOBILE

(75) Inventors: Masanori HASHIBA, Mizunami-shi (JP); Takahide YOSHIOKA, Otsu-shi (JP); Yoshiyuki OKA, Otsu-shi (JP)

Correspondence Address: GREENBLUM & BERNSTEIN, P.L.C., 1950 ROLAND CLARKE PLACE, RESTON, VA, 20191, US

(73) Assignees: TOYOTA BOSHOKU KABUSHIKI KAISHA, Aichi-ken (JP); TORAY INDUSTRIES, INC., Tokyo (JP)

(21) Appl. No.: 12/489,585

(22) Filed: Jun. 23, 2009

(30) Foreign Application Priority Data
Jun. 25, 2008 (JP) 2008-166536

(51) Int. Cl. B32B 3/10; B32B 5/18

(52) U.S. Cl. 428/195.1; 428/319.3

(57) ABSTRACT

The interior material article for an automobile of the present invention comprises sequentially a skin layer (A), a crosslinked foam layer (B) and a base layer (C), and is composed of an integrated combination of a laminated sheet in which the skin layer (A) and the crosslinked foam layer (B) are joined and the base layer (C) by vacuum molding method. The skin layer (A) comprises a polyolefin-based resin (a1), and the crosslinked foam layer (B) is a layer in which a crosslinking and foaming resin composition is crosslinked and foamed, the composition comprising a polylactic acid-based resin (b1), a polyolefin-based resin (b2) comprising a monomer unit based on ethylene and a monomer unit based on propylene, a modified polyolefin (b3) having an ester bond at its side chain, and a crosslinking aid (b4). Contents of the resin (b1), (b2) and (b3) are respectively 1% to 30% by weight, 65% to 89% by weight and 1% to 10% by weight based on 100% by weight of the total of the resin (b1), (b2) and (b3) that are contained in the crosslinking and foaming resin composition.

### INCORPORATION BY REFERENCE

The present application claims priority under 35 U.S.C. §119 of Japanese Patent Application No. 2008-166536, filed on Jun. 25, 2008, the disclosure of which is expressly incorporated by reference herein in its entirety.

### BACKGROUND OF THE INVENTION

1. Field of the Invention

The present invention relates to an interior material article for an automobile. More specifically, the present invention relates to an interior material article for an automobile provided with a crosslinked foam layer comprising a polylactic acid-based resin which is a biodegradable resin.

2. Related Art

In recent years, attention has been paid to the technique using a material originating from a plant from the viewpoint of a reduction in the discharge amount of carbon dioxide, the fixation of carbon dioxide, and others, and the use thereof has been expected. In particular, a polylactic acid-based resin has biodegradability so as to have an excellent performance from an environmental viewpoint as well as the raw material thereof can be obtained from plants. However, when the resin is used as it is, the resin cannot exhibit a sufficient performance in a product therefrom in many cases, which is different from conventionally used resins. Thus, this becomes a problem in the promotion of the use thereof.

This polylactic acid-based resin is described, for example in Japanese Patent Application Publication No. JP-A 2005-8869 and Japanese Patent Application Publication No. JP-A 2006-348060 and is known that it can be used as a foam or a foamed body.

### SUMMARY OF THE INVENTION

When an attempt is made to use this foam for an interior material article for an automobile, a crosslinked foam layer (B) consisting of the foam in a structure wherein a skin layer (A), the crosslinked foam layer (B) and a base layer (C) are laminated in this order so as to be integrated into a single unit can be caused to function as a layer for giving cushioning feeling to the skin layer (A), a layer for joining the skin layer (A) and the base layer (C) to each other, and the like.

However, it has been understood that when an actual attempt is made to use an interior material article for an automobile having this laminated structure, the use of a polylactic acid-based resin therein causes problems that sufficient bonding strengths between the individual layers are not easily obtained and a sufficient oil resistance is not easily obtained, and other problems. Furthermore, the biodegradability of the polylactic acid-based resin, which is an advantage for the environment, is a defective property which may cause a fall in the moisture-based-ageing resistance of an interior material article for an automobile and other properties thereof. Thus, it has been desired that these various properties, which are required for an interior material article for an automobile, are simultaneously satisfied at a high level as well as the above-mentioned problems are overcome.

The present invention has been made in light of the above-mentioned situation. An object of the invention is to provide an interior material article for an automobile having a skin layer (A), a crosslinked foam layer (B), and a base layer (C) that are arranged in this order, wherein various properties are satisfied with an excellent balance while a crosslinked foam containing a polylactic acid-based resin is used for the crosslinked foam layer (B).

The present invention is an interior material article for an automobile characterized in that the interior material article comprises sequentially (A) a skin layer, (B) a crosslinked foam layer and (C) a base layer, and is composed of an integrated combination of a laminated sheet in which the skin layer (A) and the crosslinked foam layer (B) are joined and the base layer (C) by vacuum molding method, that the skin layer (A) comprises a polyolefin-based resin (a1), that the crosslinked foam layer (B) is a layer in which a crosslinking and foaming resin composition is crosslinked and foamed, the composition comprising a polylactic acid-based resin (b1), a polyolefin-based resin (b2) comprising a monomer unit based on ethylene and a monomer unit based on propylene, a modified polyolefin (b3) having an ester bond at its side chain, and a crosslinking aid (b4), and that contents of the polylactic acid-based resin (b1), polyolefin-based resin (b2) and modified polyolefin (b3) in the crosslinking and foaming resin composition are respectively from 1% to 30% by weight, from 65% to 89% by weight and from 1% to 10% by weight based on 100% by weight of the total of the polylactic acid-based resin (b1), polyolefin-based resin (b2) and modified polyolefin (b3).

In the interior material article for an automobile of the present invention, three layers of the skin layer (A), the crosslinked foam layer (B) and the base layer (C) are laminated while having the crosslinked foam layer (B) formed by a crosslinking and foaming resin composition comprising a polylactic acid-based resin (b1) capable of reducing environmental loading and specified resins (b2) and (b3), whereby the interior material article for an automobile has excellent cushioning property, external appearance and touch sensitivity. The interior material article for an automobile also keeps high bonding strength certainly between the individual layers while the material can exhibit a sufficient oil resistance and an excellent moisture-based-ageing resistance.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic cross-sectional view of an interior material article for an automobile of the present invention;

FIG. 2 is a schematic explanatory view of an example for vacuum molding; and

FIG. 3 is a schematic explanatory view of another example for vacuum molding.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

### 1. Interior Material Article for Automobile

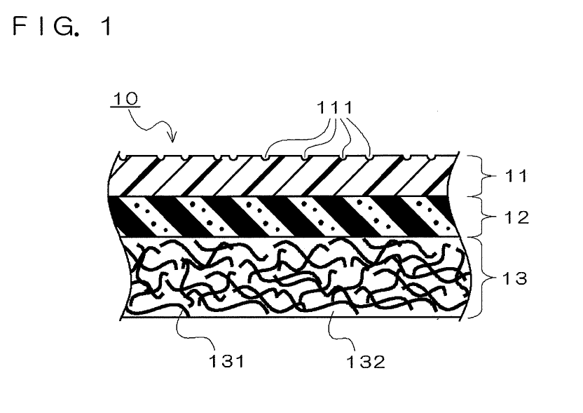

The interior material article 10 for an automobile of the present invention is characterized in that the interior material article comprises sequentially (A) a skin layer 11, (B) a crosslinked foam layer 12 and (C) a base layer 13 shown in FIG. 1, and is composed of an integrated combination of a laminated sheet 30 in which the skin layer (A) 11 and the crosslinked foam layer (B) 12 are joined and the base layer (C) 13 by vacuum molding method, that the skin layer (A) 11 comprises a polyolefin-based resin (a1), that the crosslinked foam layer (B) 12 is a layer in which a crosslinking and foaming resin composition is crosslinked and foamed, the composition comprising a polylactic acid-based resin (b1), a polyolefin-based resin (b2) comprising a monomer unit based on ethylene and a monomer unit based on propylene, a modified polyolefin (b3) having an ester bond at its side chain, and a crosslinking aid (b4), and that contents of the polylactic acid-based resin (b1), polyolefin-based resin (b2) and modified polyolefin (b3) in the crosslinking and foaming resin composition are respectively from 1% to 30% by weight, from 65% to 89% by weight and from 1% to 10% by weight based on 100% by weight of the total of the polylactic acid-based resin (b1), polyolefin-based resin (b2) and modified polyolefin (b3).

### 1-1. Skin Layer (A)

The skin layer (A) is a layer containing a polyolefin-based resin (a1) (see a layer 11 in FIG. 1). This skin layer (A) is usually positioned at the innermost side of an automobile, out of the three essential layers constituting the interior material article for an automobile of the present invention, so that the surface of this layer that does not face the crosslinked foam layer (B) is to be a designed surface.

The form of the skin layer (A) is not particularly limited and may be a sheet-form product such as a film and a sheet, and a cloth-form product such as a woven cloth and a nonwoven cloth. Among these, the skin layer (A) is particularly a sheet-form product since the product is better in adhesiveness onto the crosslinked foam layer (B) than any cloth-form product. In the case where the skin layer (A) is a sheet-form product, the skin layer (A) can lead to an excellent position trailing property and an excellent adhesiveness onto the crosslinked foam layer (B) even when the crosslinked foam layer (B) has a concave-convex shape.

The polyolefin-based resin (a1) constituting the skin layer (A) is a resin wherein a monomer unit based on an olefin is a main constituting unit, which may be referred to as “olefin unit” hereinafter. The olefin unit is generally contained in an amount of 80% or more by mole based on 100% by mole of all monomer units constituting the polyolefin-based resin (a1) contained in the skin layer (A). Examples of the olefin unit include a monomer unit based on ethylene, which may be referred to as “ethylene unit” hereinafter, a monomer unit based on propylene, which may be referred to as “propylene unit” hereinafter, and a monomer unit based on a component selected from 1-butene, 2-methyl-1-propene, 1-pentene, 1-hexene, 4-methyl-1-pentene, 5-methyl-1-hexene and the like. These monomer units may be contained by singly or in combination of two or more types.

The main constituting unit is preferably an ethylene unit and/or a propylene unit out of the above-mentioned monomer units. In particular, the ethylene unit and the propylene unit are contained in a total amount of preferably 80% or more by mole, more preferably 85% or more by mole, and further preferably 90% or more by mole based on 100% by mole of all the monomer units contituting the polyolefin-based resin (a1). The ethylene unit and the propylene unit may be contained in a total amount of 100% by mole. When the polyolefin-based resin (a1) contains two or more types of constituting units (that is, the resin (a1) is a copolymer), the resin may be a random copolymer such as ethylene-propylene random copolymer or a block copolymer such as ethylene-propylene block copolymer.

The polyolefin-based resin (a1) may not have rubbery property. However, the resin (a1) preferably has rubbery property. The polyolefin-based resin having rubbery property is, for example, a polyolefin-based thermoplastic elastomer, which is be referred to as “TPO” hereinafter. The TPO is usually a mixture of a non-rubbery polyolefin-based polymer and a rubbery polyolefin-based copolymer. The non-rubbery polyolefin-based polymer and the rubbery polyolefin-based copolymer may be crosslinked or not.

The non-rubbery polyolefin-based polymer is preferably a polymer comprising ethylene unit and/or propylene unit as main constituting unit, wherein the ethylene unit and propylene unit are contained in a total amount of 80% or more by mole based on all monomer units constituting the non-rubbery polyolefin-based resin. When the non-rubbery polyolefin-based polymer contains two or more types of constituting units (that is, the resin is a copolymer), the resin may be a random copolymer such as ethylene-propylene random copolymer or a block copolymer such as ethylene-propylene block copolymer. Among these, propylene homopolymer is preferred.

On the other hand, examples of the rubbery polyolefin-based copolymer include ethylene-propylene copolymer rubber (EPM), ethylene-propylene-non-conjugated diene copolymer rubber (EPDM) and the like. These may be used singly or in combination of two or more types thereof.

The skin layer (A) may contain other components than the polyolefin-based resin (a1). The content of the other components is not particularly limited and is usually 10 parts or less by weight when the amount of the polyolefin-based resin (a1) contained in the skin layer (A) is regarded as 100 parts by weight. Examples of the other components include an antioxidizing agent such as phenol-based antioxidizing agent and phosphorus-based antioxidizing agent; a light stabilizer such as hindered amine-based light stabilizer; a ultraviolet absorber such as benzotriazole-based ultraviolet absorber; a lubricant such as stearic acid compound; an antistatic agent; a softener such as mineral oil and processing oil; a plasticizer; a pigment; a filler of talc or the like; a flame retardant; a flame retardant auxiliary; an antibacterial agent, a deodorizer and the like. The other components may be used singly or in combination of two or more types thereof.

The thickness of the skin layer (A) is not particularly limited and is preferably in the range from 0.2 to 1.0 mm. When the thickness is in this range, a high shapability can be obtained in vacuum molding and further a sufficient strength can be obtained. In particular, a high resistance against scratching, sticking and the like can be obtained so that characteristics suitable for an interior material article for an automobile can be obtained. The thickness is more preferably from 0.3 to 0.9 mm and further preferably from 0.35 to 0.7 mm.

Additionally, the correlation between the thickness of the skin layer (A) and one of the other layers is not particularly limited. When the thickness of the skin layer (A) is represented by t_{A} and that of the crosslinked foam layer (B) is represented by t_{B}, the ratio between the thicknesses (t_{A}/t_{B}) is preferably set into the range between 0.05 and 1.0. When the ratio is in this range, a high shapability can be obtained in vacuum molding and further a sufficient strength can be obtained. In particular, a high resistance against scratching, sticking and the like can be obtained so that characteristics suitable for an interior material article for an automobile can be obtained. The thickness ratio (t_{A}/t_{B}) is more preferably from 0.1 to 0.8 and further preferably from 0.11 to 0.75.

The hardness of the skin layer (A) is not particularly limited and the Shore A hardness thereof is preferably in the range from 70 to 90. When the Shore A hardness is in this range, a high shapability can be obtained in vacuum molding and further a sufficient strength can be obtained. In particular, a high resistance against scratching, sticking and the like can be obtained so that characteristics suitable for an interior material article for an automobile can be obtained. The Shore A hardness is more preferably from 75 to 85 and further preferably from 77 to 83.

The skin layer (A) can be one produced by a known method. When a forming material for the skin layer (A) is in sheet-form, in particular, the sheet-form product can be manufactured by extrusion molding, wherein a raw material is extruded out from a mold-opening (such as a T die) corresponding to the sheet shape which may be made into many variations, calendaring, biaxial drawing or the like.

The skin layer (A) may have a concave-convex pattern due to concave part 111 in FIG. 1 or the like formed on the external surface thereof. Examples of the concave-convex pattern include a grain pattern (skin grain pattern), a satin pattern, a hairline pattern and the like. This concave-convex pattern is a pattern obtained by molding. The pattern obtained by molding is a pattern formed by pushing the surface of a heated forming material for the skin layer (A) or the heated skin layer (A) onto a mold and transferring, onto the layer (A), a concave-convex pattern formed beforehand in the inner surface of the mold. That is, the molding may be embossing finish or the like. When the skin layer (A) has the concave-convex pattern, a decorative effect can be obtained so that a beautifully designed surface can be formed. Furthermore, the touch sensitivity at the skin layer (A) can be improved and the friction resistance can also be improved.

### 1-2. Crosslinked Foam Layer (B)

The crosslinked foam layer (B) is a layer obtained by crosslinking and foaming a crosslinking and foaming resin composition comprising a polylactic acid-based resin (b1), a polyolefin-based resin (b2), a modified polyolefin (b3), and a crosslinking aid (b4) (see a layer 12 in FIG. 1). When the interior material article for an automobile of the present invention has the layer (B), the material article can have an excellent cushioning property as a whole. In addition, the form of a forming material for the crosslinked foam layer (B) is not particularly limited and is usually a sheet-form such as a film and sheet.

1-2-1. Polylactic Acid-Based Resin (b1)

The polylactic acid-based resin (b1) is a resin comprising a monomer unit based on lactic acid and/or lactide, which may be referred to as “lactic acid unit” hereinafter, as a main constituting unit. Examples of lactic acid include L-lactic acid and D-lactic acid. Examples of lactide include L-lactide, D-lactide, meso-lactide, and DL-lactide. These compounds may be used singly or in combination of two or more types thereof. The content of the lactic acid unit is not particularly limited and is usually 70% or more by mole based on to 100% by mole of all constituting units that constitute the polylactic acid-based resin (b1). The content thereof may be 100% by mole.

The polylactic acid-based resin (b1) may comprise a constituting unit based on a monomer other than lactic acid and lactide, which may be referred to as “other unit” hereinafter. In the case where the other unit is contained in the polylactic acid-based resin (b1), the content thereof is usually 30% or less by molee and preferably 10% or less by mole based on to 100% by mole of all constituting units that constitute the polylactic acid-based resin (b1). The lower limit is usually 1% or more by mole.

Examples of the monomer other than lactic acid and lactide, which is to constitute the other unit, include a polyvalent carboxylic acid, a polyhydric alcohol, a hydroxycarboxylic acid, a lactone and the like. These may be used singly or in combination of two or more types thereof.

Examples of the polyvalent carboxylic acid include oxalic acid, malonic acid, succinic acid, glutaric acid, adipic acid, azelaic acid, sebacic acid, dodecanedioic acid, fumaric acid, cyclohexane dicarboxylic acid, terephthalic acid, isophthalic acid, phthalic acid, 2,6-naphthalene dicarboxylic acid, anthrathene dicarboxylic acid, 5-sodium sulfoisophthalic acid, 5-tetrabutyl phosphonium sulfoisophthalic acid and the like. These polyvalent carboxylic acids may be used singly or in combination of two or more types thereof.

Examples of the polyhydric alcohol include ethylene glycol, propylene glycol, butane diol, hexane diol, heptane diol, octane diol, nonane diol, decane diol, 1,4-cyclohexane diol, neopentyl glycol, glycerol, pentaerythritol, bisphenol A, aromatic polyalcohol in which ethyleneoxide is added to bisphenol, diethylene glycol, triethylene glycol, polyethylene glycol, polypropylene glycol, polytetramethylene glycol and the like. These polyhydric alcohols may be used singly or in combination of two or more types thereof.

Examples of the hydroxycarboxylic acid include glycolic acid, 3-hydroxy butyric acid, 4-hydroxy butyric acid, 4-hydroxy valeric acid, 6-hydroxy hexanoic acid, hydroxyl benzoic acid, malic acid and the like. The hydroxyl carboxylic acid may be used singly or in combination of two or more types thereof.

In addition, examples of the above-mentioned lactone include glycolide, ε-caprolactone glycolide, ε-caprolactone, β-propiolactone, δ-butyrolactone, γ-butyrolactone, β-butyrolactone, pivalolactone, δ-valerolactone and the like. These lactones may be used singly or in combination of two or more types thereof.

The molecular weight and the molecular weight distribution of the polylactic acid-based resin (b1) are not particularly limited and the lower limit of the weight-average molecular weight thereof is preferably 10,000 or more. On the other hand, the upper limit of the weight-average molecular weight is 800,000 or less. When the weight-average molecular weight of the polylactic acid-based resin (b1) is in the above range, in the case where the laminated sheet is formed and the case where the laminated sheet and a forming material for the base layer (C) are joined to be integrated, excellent moldability is exhibited. Additionally, the phase structure thereof is easily controlled in the crosslinked foam layer (B). The lower limit thereof is more preferably 50,000 or more, and further preferably 100,000 or more. On the other hand, the upper limit thereof is more preferably 600,000 or less, and further preferably 400,000 or less. The weight-average molecular weight is measured by gel permeation chromatography (GPC) using hexafluoroisopropanol as a solvent, and is a molecular weight in terms of poly methyl methacrylate (PMMA).

The concentration of the terminated carboxyl group in the polylactic acid-based resin (b1) is not particularly limited and is preferably in the range from 0 to 20 equivalents per ton. When the concentration is in this range, the hydrolysis of the polylactic acid-based resin is restrained so that an excellent ageing resistance can be obtained in the resultant crosslinked foam layer (B) (in particular, the bending strength can be effectively maintained at high temperature and high humidity). The concentration is more preferably from 0 to 15 equivalents per ton and further preferably from 0 to 10 equivalents per ton. The concentration of the terminated carboxyl group is measured by dissolving the polylactic acid-based resin (b1), which is a measuring target, into chloroform, adding benzyl alcohol (compatibility accelerator) and phenolphthalein (acid-base indicator) to the solution, and then titrating the resultant with a predetermined-concentration solution of potassium hydroxide in ethanol.

In order to control the concentration of the terminated carboxyl group into the preferred range, an addition reaction type compound or the like may be used. Example thereof includes a carbodiimide compound, an epoxy compound, an oxazoline compound, an oxazine compound, an aziridine compound and the like. These compounds may be used singly or in combination of two or more types thereof. The compound makes it possible to terminate a carboxyl terminal of the polylactic acid-based resin so that the concentration of the terminated carboxyl group in the preferred range can be obtained.

The content of the polylactic acid-based resin (b1) in the crosslinking and foaming resin composition is in the range from 1% to 30% by weight based on 100% by weight of the total of the polylactic acid-based resin (b1), the polyolefin-based resin (b2) and the modified polyolefin (b3). When the content is in this range, excellent foamability and flexibility can be exhibited while the crosslinking and foaming resin composition contains polylactic acid. Additionally, the crosslinking and foaming resin composition can be rendered a crosslinked foam layer (B) excellent in various endurances (such as oil resistance and humidity-based-ageing resistance). The content is preferably from 1% to 25% by weight, and more preferably from 1% to 22% by weight.

1-2-2. Polyolefin-Based Resin (b2)

The polyolefin-based resin (b2) is a resin containing ethylene unit and propylene unit. Regarding the ethylene unit and propylene unit, both of the species may be contained in a single resin, or may be separately contained in different resins. Specifically, examples of the polyolefin-based resin (b2) are follows: (1) a mixture of a polypropylene-based resin (b21) comprising propylene unit as a main unit and ethylene unit as a subsidiary unit, and a polyethylene-based resin (b22) comprising ethylene unit as a main unit, and a unit other than the propylene unit as a subsidiary unit; (2) a mixture of a polypropylene-based resin comprising propylene unit as a main unit and a unit other than ethylene unit as a subsidiary unit, and a polyethylene-based resin comprising ethylene unit as a main unit and a unit other than propylene unit as a subsidiary unit; (3) a mixture of a polypropylene-based resin comprising propylene unit as a main unit and ethylene unit as a subsidiary unit, and a polyethylene-based resin comprising ethylene unit as a main unit and propylene unit as a subsidiary unit; (4) a mixture of a polypropylene-based resin comprising propylene unit as a main unit and a unit other than ethylene unit as a subsidiary unit, and a polyethylene-based resin comprising ethylene unit as a main unit and a unit other than propylene unit as a subsidiary unit; (5) a polypropylene-based resin (b21) comprising propylene unit as a main unit and ethylene unit as a subsidiary unit; and (6) a polyethylene-based resin comprising ethylene unit as a main unit and propylene unit as a subsidiary unit, and the like.

In the embodiments (1) to (6) above, the “main unit” means a unit including the amount of which is 60% or more by mole, preferably 70% or more by mole, and more preferably 80% or more by mole based on 100% by mole of all units constituting each of the resins unless otherwise specified later. Similarly, the “subsidiary unit” means a unit including the amount of which is 40% or less by mole, preferably 30% or less by mole, and more preferably 20% or less by mole based on 100% by mole of all units constituting each of the resins unless otherwise specified later. Copolymerizing form of each copolymers described in the embodiments (1) to (6) are not particularly limited and they may be a block copolymer, a random copolymer, or the like. The above-mentioned other unit does not include a unit based on a monomer which is polymerized to constitute a modified polyolefin (b3) which will be described later, the monomer having an ester bond such as vinyl acetate. Examples of the monomer which is to be the other unit, include an α-olefin such as 1-butene, 1-pentene, 1-hexene, 3,3-dimethyl-1-butene, 4-methyl-1-pentene, 4,4-dimethyl-1-pentene, 1-octene, 1-decene, 1-dodecene, 1-tetradecene and 1-octadecene. The other unit may be contained singly or in combination of two or more types.

The polyolefin-based resin (b2) may be the same as the polyolefin-based resin (a1) which is contained in the skin layer (A); however, the polyolefin-based resin (b2) is usually different therefrom. Furthermore, the polyolefin-based resin (b2) is usually a resin having no rubbery property.

The preferable embodiment for the polyolefin-based resin (b2) is the embodiments (1) and (5) among the embodiments (1) to (5).

For the polypropylene-based resin (b21) in the embodiments (1) and (5), the contents of the propylene unit and ethylene unit constituting the polypropylene-based resin (b21) are preferably from 75% to 99% by mole and 1% to 25% by mole respectively based on 100% by mole of all units constituting the polypropylene-based resin (b21). When the contents are in the above ranges, a preferred peak temperature (melting point) in a differential scanning calorimetric curve that will be described later, and a preferred MFR that will be described later are easily obtained so that excellent heat resistance and foamability are exhibited. The contents of the propylene unit and ethylene unit are more preferably from 80% to 99% by mole and 1% to 20% by mole, respectively. The contents of the propylene unit and ethylene unit are further preferably from 85% to 98% by mole and 2% to 15% by mole, respectively. The contents of the propylene unit and ethylene unit are furthermore preferably from 90% to 98% by mole and 2% to 10% by mole, respectively. The contents of the propylene unit and ethylene unit are particularly from 95% to 98% by mole and 2% to 5% by mole, respectively.

The molecular weight and the molecular weight distribution of the polypropylene-based resin (b21) are not particularly limited. The lower limit of the weight-average molecular weight of the polypropylene-based resin (b21) is preferably 150,000 or more. On the other hand, the upper limit of the weight-average molecular weight is preferably 500,000 or less. When the weight-average molecular weight of the polypropylene-based resin (b21) is in the above range, in the case where the laminated sheet is formed and the case where the laminated sheet and a forming material for the base layer (C) are joined to be integrated, excellent moldability is exhibited and the phase structure thereof is easily controlled in the crosslinked foam layer (B). The lower limit thereof is more preferably 200,000 or more, and further preferably 250,000 or more. On the other hand, the upper limit thereof is more preferably 450,000 or less, and further preferably 400,000 or less. The weight-average molecular weight is measured by gel permeation chromatography (GPC) using o-dichlorobenzene as a solvent, and is a molecular weight in terms of polystyrene.

The thermal characteristic of the polypropylene-based resin (b21) is not particularly limited and the peak temperature in the scanning differential calorimetric curve thereof, which may be referred to as the “melting point” hereinafter, is preferably in the range from 125° C. to 170° C. When the melting point is in the above range, higher heat resistance for the crosslinked foam layer (B) can be obtained. Additionally, when a forming material for the crosslinked foam layer is formed by using the crosslinking and foaming resin composition which is to be crosslinked and foamed, the decomposition of a foaming agent in a molding machine such as an extruder can be restrained so that the forming material for the crosslinked foam layer (B) can be obtained having evener foam shape. The melting point is more preferably in the range from 130° C. to 160° C.

The MFR of the polypropylene-based resin (b21) is not particularly limited and is preferably in the range from 0.1 to 30 g/10-minutes. When the MFR is in the above range, higher heat resistance for the crosslinked foam layer (B) can be obtained. Additionally, when a forming material for the crosslinked foam layer (B) is formed by using the crosslinking and foaming resin composition which is to be crosslinked and foamed, the decomposition of a foaming agent in a molding machine such as an extruder can be restrained so that the forming material for the crosslinked foam layer (B) can be obtained having evener foamed cell. Additionally, mechanical properties such as tensile strength and elongation can be kept at high levels and the breakdown of the foams due to impact or the like can also be restrained, so that the resin can lead to a crosslinked foam layer (B) having excellent cushioning property. The MFR thereof is more preferably in the range from 0.5 to 10 g/10-minutes.

The MFR of the polypropylene-based resin (b21) herein is a value obtained by making a measurement in accordance with JIS K 7210 (1999) under conditions that the temperature and the load are 230° C. and 2.16 kgf, respectively.

The polyethylene-based resin (b22) used in the polyolefin-based resin (b2l) under the embodiment (1) above is a copolymer containing an ethylene unit in an amount of 70% or more by mole. The copolymer has a preferred peak temperature (melting point) in a differential scanning calorimetric curve that will be described later, and a preferred MFR that will be described later are easily obtained so that excellent heat resistance and foamability are exhibited. Further, the contents of the ethylene unit and the other unit are preferably from 70% to 99% by mole and 1% to 30% by mole, respectively. And the contents of the ethylene unit and the other unit are more preferably from 75% to 98% by mole and 2% to 25% by mole, respectively. Particularly, the contents of the ethylene unit and the other unit are from 80% to 97% by mole and 3% to 20% by mole, respectively.

Examples of the polyethylene-based resin (b22) include the so-called low density polyethylene, middle density polyethylene, high density polyethylene, linear low density polyethylene or the like. The density of the polyethylene-based resin (b22) is preferably in the range from 0.915 to 0.970 g/cm³. When the density is in this range, sufficient strength and heat resistance can be made consistent with each other. The density thereof is more preferably from 0.920 to 0.960 g/cm³. The polyethylene-based resin (b22) is preferably a low density polyethylene, middle density polyethylene and linear low density polyethylene. For example, the preferable density of the polyethylene-based resin (b22) is in the range from 0.915 to 0.945 g/cm³. Especially, a linear low density polyethylene is preferred.

The monomer forming the above-mentioned other unit is not particularly limited, but is preferably an α-olefin. Examples of the α-olefin include 1-butene, 1-penten, 1-hexene, 3,3-dimethyl-1-butene, 4-methyl-1-pentene, 4,4-dimethyl-1-pentene, 1-octene, 1-decene, 1-dodecene, 1-tetradecene, 1-octadecene and the like. Among these, an α-olefin having carbon atoms of 3 to 12 is preferable and at least one selected from 1-butene, 1-hexene, 4-methyl-1-pentene and 1-octene is particularly preferred.

The molecular weight and the molecular weight distribution of the polyethylene-based resin (b22) are not particularly limited. The lower limit of the weight-average molecular weight of the polyethylene-based resin (b22) is preferably 80,000 or more. On the other hand, the upper limit of the weight-average molecular weight is preferably 400,000 or less. When the weight-average molecular weight of the polyethylene-based resin (b22) is in the above range, in the case where the laminated sheet is formed and the case where the laminated sheet and a forming material for the base layer (C) are joined to be integrated, excellent moldability is exhibited and the phase structure thereof is easily controlled in the crosslinked foam layer (B). The lower limit thereof is more preferably 100,000 or more, and further preferably 110,000 or more. On the other hand, the upper limit thereof is more preferably 380,000 or less, and further preferably 350,000 or less. The weight-average molecular weight is measured by gel permeation chromatography (GPC) using o-dichlorobenzene as a solvent, and is a molecular weight in terms of polystyrene.

The MFR of the polyethylene-based resin (b22) is not particularly limited and is preferably in the range from 0.5 to 30 g/10-minutes. When the MFR is in the above range, higher heat resistance for the crosslinked foam layer (B) can be obtained. Additionally, when a forming material for the crosslinked foam layer is formed by using the crosslinking and foaming resin composition which is to be crosslinked and foamed, the decomposition of a foaming agent in a molding machine such as an extruder can be restrained so that the forming material for the crosslinked foam layer (B) can be obtained having evener foamed cell. Additionally, mechanical properties such as tensile strength and elongation can be kept at high levels and the breakdown of the foams due to impact or the like can also be restrained, so that the matchability with the skin layer (A) is also excellent. The MFR thereof is more preferably in the range from 1.0 to 15 g/10-minutes, and further preferably from 1.5 to 8 g/10-minutes.

The MFR of the polyethylene-based resin (b22) herein is a value obtained by making a measurement in accordance with JIS K 7210 (1999) under conditions that the temperature and the load are 190° C. and 2.16 kgf, respectively.

The preferable embodiment for the polyolefin-based resin (b2) is the embodiments (1) and (5), as described above. Among these, the embodiment (1) is preferred. That is to say, the polyolefin-based resin (b2) preferably contains both the polypropylene-based resin (b21) and the polyethylene-based resin (b22). Of these resins, the polypropylene-based resin (b21) contributes largely to an improvement in heat resistance and oil resistance, and the polyethylene-based resin (b22) constitutes largely to an improvement in impact resistance at low temperature and cushioning property. Accordingly, when the polyolefin-based resin (b2) contains both of these resins, the crosslinked foam layer (B) can be obtained having an excellent physical property balance.

In the case where the polyolefin-based resin (b2) contains both the polypropylene-based resin (b21) and the polyethylene-based resin (b22), the content ratio of the polypropylene-based resin (b21) is preferably in the range from 10% to 90% by weight, more preferably from 30% to 80% by weight and particularly from 40% to 70% by weight based on 100% by weight of the total of these resins.

The content of the polyolefin-based resin (b2) in the crosslinking and foaming resin composition is in the range from 65% to 89% by weight based on 100% by weight of the total of the polylactic acid-based resin (b1), the polyolefin-based resin (b2) and the modified polyolefin (b3). When the content is in this range, excellent foamability and flexibility can be exhibited while the crosslinking and foaming resin composition contains the polylactic acid-based resin (b1) as much as possible. Additionally, the crosslinking and foaming resin composition can be rendered a crosslinked foam layer (B) excellent in various endurances (such as oil resistance and humidity-based-ageing resistance). The content thereof is more preferably from 65% to 85% by weight, and further preferably from 70% to 80% by weight.

1-2-3. Modified Polyolefin (b3)

The modified polyolefin (b3) is a resin having an ester bond (—CO—O—) at its side chain, and is not any polyester having an ester bond at its main chain. When the crosslinking and foaming resin composition contains this modified polyolefin (b3), the compatibility between the polylactic acid-based resin (b1) and the polyolefin resin (b2) can be improved.

The ester bond in the modified polyolefin (b3) may be (1) an ester bond introduced by polymerizing a monomer having an ester bond, or (2) an ester bond introduced by grafting an ester bond onto a polymer having no ester bond. Among these, the embodiment (1) is preferred. In the embodiment (1), the modified polyolefin (b3) may be a homopolymer of a monomer having an ester bond. In general, the modified polyolefin (b3) is a copolymer of a monomer having an ester bond and other monomer.

The above-mentioned monomer having an ester bond may be any monomer as far as the monomer has both an ester bond and a polymerizable unsaturated bond. Examples of the monomer having both an ester bond and a polymerizable unsaturated bond, include a carboxylic acid vinyl ester, a (meth)acrylic acid ester and the like. These compounds may be used singly or in combination of two or more types thereof.

Examples of the carboxylic acid vinyl ester include vinyl acetate, vinyl formate, vinyl propionate, vinyl butyrate, vinyl caproate, vinyl caprylate, vinyl caprate, vinyl laurate, vinyl myristate, vinyl palmitate, vinyl stearate, isopropenyl acetate, 1-butenyl acetate, vinyl pivalate, vinyl 2-ethylhexanoate, vinyl cyclohexanecarboxylate, vinyl benzoate, vinyl cinnamate, vinyl monochloroacetate, divinyl adipate, vinyl methacrylate, vinyl crotonate, vinyl sorbate and the like. These compounds may be used singly or in combination of two or more types thereof.

In addition, examples of the (meth)acrylic acid ester include methyl acrylate, ethyl acrylate, butyl acrylate, phenyl acrylate, methyl methacrylate, ethyl methacrylate, butyl methacrylate, pentyl methacrylate, vinyl methacrylate and the like. These compounds may be used singly or in combination of two or more types thereof.

Among these, a carboxylic acid vinyl ester is preferable and vinyl acetate is particularly preferred.

On the other hand, the other monomer may be any olefin. Example thereof includes ethylene, propylene, α-olefin and the like. Examples of the α-olefin include 1-butene, 1-pentene, 1-hexene, 4-methly-1-pentene, 3,3-dimethyl-1-butene, 4,4-dimethly-1-pentene, 1-octene, 1-decene, 1-dodecene, 1-tetradecene, 1-octadecene and the like. These compounds may be used singly or in combination of two or more types thereof. The other monomer is preferably an ethylene.

The modified polyolefin (b3) is preferably an ethylene-vinyl acetate copolymer comprising a monomer unit based on vinyl acetate, which may be referred to as “vinyl acetate unit” hereinafter, and a monomer unit based on ethylene, referred to as “ethylene unit”. The ethylene-vinyl acetate copolymer may be referred to as “EVA” hereinafter.

The contents of the vinyl acetate unit and ethylene unit in the EVA are not particularly limited. The vinyl acetate unit and ethylene unit are contained preferably in a total amount of 95% or more by mole based on 100% by mole of all units constituting the EVA. The vinyl acetate unit and ethylene unit may be contained in a total amount of 100% by mole. In addition, the content of the vinyl acetate unit is preferably in the range from 5% to 25% by mole based on 100% by mole of all units constituting the EVA. When the content of the vinyl acetate unit is in the above range, an excellent effect of promoting the compatibility between the polylactic acid-based resin (b1) and the polyolefin-based resin (b2) is exhibited so that the content ratio of the polylactic acid-based resin (b1) can be effectively increased. Additionally, an appropriate crystallinity can be obtained so that the EVA is also excellent in handleability. The content thereof is more preferably from 7% to 23% by mole and further preferably from 9% to 21% by mole.

The molecular weight and the molecular weight distribution of the EVA are not particularly limited. The lower limit of the weight-average molecular weight of the EVA is preferably 150,000 or more. On the other hand, the upper limit of the weight-average molecular weight is preferably 500,000 or less. The lower limit thereof is more preferably 200,000 or more, and further preferably 250,000 or more. On the other hand, the upper limit thereof is more preferably 450,000 or less, and further preferably 400,000 or less. The weight-average molecular weight is measured by gel permeation chromatography (GPC) using chloroform as a solvent, and is a molecular weight in terms of polystyrene.

The content of the modified polyolefin (b3) in the crosslinking and foaming resin composition is in the range from 1% to 10% by weight based on 100% by weight of the total of the polylactic acid-based resin (b1), the polyolefin-based resin (b2) and the modified polyolefin (b3). When the content is in this range, the modified polyolefin (b3) can lead to a sufficient compatibility between the polylactic acid-based resin (b1) and the polyolefin-based resin (b2) while the crosslinking and foaming resin composition contains the polylactic acid-based resin (b1) as much as possible. Additionally, the crosslinking and foaming resin composition containing the modified polyolefin (b3) is excellent in handleability when a forming material for the crosslinked foam layer (B) is produced. Further, appearance and endurance of the resultant are excellent. The content thereof is more preferably from 2% to 9% by weight, and further preferably from 3% to 8% by weight.

1-2-4. Crosslinking Aid (b4)

The crosslinking aid (b4) is a component making it possible to crosslink the polylactic acid-based resin (b1), and further crosslink the polyolefin-based resin (b2). When the crosslinking and foaming resin composition contains the crosslinking aid (b4), the polylactic acid-based resin (b1) and the polyolefin-based resin (b2) which are usually difficult to be crosslinked, and the like can be crosslinked. The polyolefin-based resin (b2) is a polypropylene-based resin in particular. When the polylactic acid-based resin (b1) and the polyolefin-based resin (b2) are crosslinked, the resultant crosslinked foam layer (B) is excellent in heat resistance and moldability. The crosslinking aid (b4) is usually a polyfunctional monomer (or polyfunctional compound) having in the molecule thereof plural double bonds or triple bonds.

Examples of the crosslinking aid (b4) include divinylbenzene; an acrylate-based or methacrylate-based compound such as 1,6-hexanediol dimethacrylate, ethyleneglycol diacrylate, ethyleneglycol dimethacrylate, trimethylolpropane trimethacrylate, tetramethylolmethane triacrylate, 1,9-nonanediol dimethacrylate and 1,10-decanediol dimethacrylate; a carboxylic acid allyl ester such as triallyl trimellitate, triallyl pyromellitate and diallyl oxalate; an ally ester of cyanuric acid or isocyanuric acid such as triallyl cyanurate and triallyl isocyanurate; a maleimide compound such as N-phenylmaleimide and N,N′-m-phenylbismaleimide; a compound having two or more triplet bonds, such as dipropargyl phthalate and dipropargyl maleate; and the like. These compounds may be used singly or in combination of two or more types thereof.

Among these compounds, divinylbenzene, 1,6-hexanediol dimethacrylate and trimethylolpropane trimethacrylate are preferable.

The externally blending amount of the crosslinking aid (b4) in the crosslinking and foaming resin composition is in the range from 1 to 10 parts by weight based on 100 parts by weight of the total of the polylactic acid-based resin (b1), the polyolefin-based resin (b2) and the modified polyolefin (b3). When the amount is in the above range, excellent crosslinking effect can be obtained and a crosslinked foam layer (B) can be formed having an excellent foamability and external appearance. The content thereof is more preferably from 2 to 8 parts by weight and further preferably from 2 to 7 parts by weight.

1-2-5. Foaming Agent (b5)

The crosslinking and foaming resin composition usually contains a foaming agent (b5) besides the polylactic acid-based resin (b1), the polyolefin-based resin (b2), the modified polyolefin (b3) and the crosslinking aid (b4). The foaming agent (b5) is not particularly limited and various foaming agents may be used. Of the agents, a thermally decomposable foaming agent is preferred and an organic thermally decomposable foaming agent is more preferred. Examples of the organic thermally decomposable foaming agent include azodicarbonamide, benzenesulfonylhydrazide, N,N′-dinitrosopentamethylenetetramine, toluenesulfonylhydrazide, azobisisobutyronitrile, barium azodicarboxylate, azodiaminobenzene, azodicyclohexylnitrile, 4,4′-oxybis(benzenesulfonylhydrazide), N,N′-dimethyl-N,N-dinitrosoterephthalamide, diphenylsulfone-3,3′-disulfonylhydrazide, 4,4′-diphenyldisulfonylazide, p-tolueneformanylazide and the like. These compounds may be used singly or in combination of two or more types thereof.

When the foaming agent (b5) is used, the blending amount thereof is not particularly limited. The amount is preferably in the range from 1 to 50 parts by weight when the total amount of the polylactic acid-based resin (b1), the polyolefin-based resin (b2), the modified polyolefin (b3) and the crosslinking aid (b4) is regarded as 100 parts by weight. When the amount is in the above range, the crosslinking and foaming resin composition is excellent in foamability and the resultant crosslinked foam layer (B) can be excellent in strength and heat resistance. Further, the blending amount is more preferably from 1 to 25 parts by weight.

In addition, the crosslinking and foaming resin composition may contain a decomposition temperature adjustor capable of adjusting the decomposition temperature of the foaming agent (b5) together with the foaming agent (b5). Examples of the decomposition temperature adjustor include zinc stearate, zinc oxide, urea and the like. These compounds may be used singly or in combination of two or more types thereof.

### 1-2-6. Other Component Contained in the Crosslinking and Foaming Resin Composition

The crosslinking and foaming resin composition may contain a other component besides the polylactic acid-based resin (b1), the polyolefin-based resin (b2), the modified polyolefin (b3), the crosslinking aid (b4) and the foaming agent (b5). The content thereof is usually 5 parts or less by weight when the total amount of the polylactic acid-based resin (b1), the polyolefin-based resin (b2), and the modified polyolefin (b3) contained in the crosslinking and foaming resin composition is regarded as 100 parts by weight.

As the other component capable of formulating to the crosslinking and foaming resin composition, an end-capping agent such as a polyfunctional carbodiimide compound and a polyfunctional epoxy compound; an organic peroxide such as dicumyl peroxide; a biodegradation promoter; a foaming agent decomposition promoter; a blocking inhibitor; a thickener; a foam stabilizer; a metallic-damage inhibitor; an antioxdizing agent such as phenol-based antioxidizing agent and phosphorus-based antioxidizing agent; a light stabilizer such as hindered amine-based light stabilizer; a ultraviolet absorber such as benzotriazole-based ultraviolet absorber; a lubricant such as stearic acid compound; an antistatic agent; a softener such as mineral oil and processing oil; a plasticizer; a pigment; a filler of talc or the like; a flame retardant; a flame retardant auxiliary; an antibacterial agent, a deodorizer and the like. These compounds may be used singly or in combination of two or more types thereof.

### 1-2-7. Preparation of Crosslinking and Foaming Resin Composition and Fabrication of Forming Material for Crosslinked Foam Layer (B)

The method for preparing the crosslinking and foaming resin composition which is to be crosslinked and foamed to form the crosslinked foam layer (B) is not particularly limited. The crosslinking and foaming resin composition may be prepared by mixing a foaming agent (b5) with a resin composition containing the polylactic acid-based resin (b1), the polyolefin-based resin (b2), the modified polyolefin (b3) and the crosslinking aid (b4), and then melting and kneading the mixture at a temperature not higher than the decomposition temperature (foaming temperature) of the foaming agent (b5) by means of a kneading machine such as a monoaxial extruder, a biaxial extruder, a Banbury mixer, a kneading mixer and a mixing roll. Thereafter, the crosslinking and foaming resin composition may be shaped or molded into a sheet form, so as to yield a sheet-form product not to be crosslinked.

Furthermore, the method comprises a process in which the crosslinking and foaming resin composition (molded article consisting of the crosslinking and foaming resin composition, such as the sheet-form product) is subjected to crosslinking and foaming. The crosslinking process and the foaming process may be separately conducted or simultaneously conducted.

In the crosslinking process, the crosslinking may be conducted by various methods. Example thereof includes a method using the radiation of an ionizing radial ray, and a method using an organic peroxide (crosslinking initiator). These methods may be conducted singly or in combination of two or more types thereof. Among these methods, a method using the radiation of an ionizing radial ray is preferred. Examples of the ionizing radial ray in the ionizing radial ray radiation include an electron beam, an X-ray, a β-ray, and a γ-ray, or the like. These ionizing radial rays may be used singly or in combination of two or more types thereof. The radiation dose of the ionizing radial ray is not particularly limited, but is preferably in the range from 1 to 300 kGy. When the ionizing radial ray is radiated, the molded article consisting of the crosslinking and foaming resin composition usually turns to a molded article of a crosslinked and non-foamed resin. The resultant molded article is then heated at a temperature not lower than the decomposition temperature of the foaming agent (b5) so as to be foamed, thereby yielding a forming material for the crosslinked foam layer (B).

The timing at which the composition is crosslinked is not particularly limited. Thus, the composition may be crosslinked at any timing selected from a time before conducting foaming, a time in the middle of conducting foaming and a time after foaming. The crosslinking may be continuously conducted over two or more of these times.

On the other hand, in the foaming process, the method for the foaming is not particularly limited and a suitable one may be selected according to the used foaming agent (b5). When the crosslinking and foaming resin composition contains a thermally decomposable foaming agent as the foaming agent (b5), the crosslinking and foaming resin composition or a molded article of a crosslinked and non-foamed resin is subjected to heating to a temperature not lower than the decomposition temperature of the foaming agent (b5) and not lower than the melting point of the resin having the highest melting point among the resins (for example, the temperature from 190° C. to 290° C.) to yield a material for forming the crosslinked foam layer (B).

The heating method is not particularly limited and example thereof includes a heating method using hot wind, infrared rays, a metal bath, an oil bath, a salt bath, or the like. These means may be used singly or in combination of two or more types thereof.

In the case where crosslinking is conducted before foaming and/or in the middle of foaming, it is preferred to maintain the differences in crosslinking degree between the polylactic acid-based resin (b1), the polyolefin-based resin (b2) and the modified polyolefin (b3) at small levels. When the crosslinking degree differences are maintained at small levels, a material for forming the crosslinked foam layer (B) having an evener foamability can be effectively obtained. Maintaining of the crosslinking degree differences at small levels can be attained, specifically, by setting the absolute values of the differences between the gel fractions in the individual resins (b1), (b2) and (b3) into the range between 0 and 50. The absolute values of the differences between the gel fractions are preferably in the range from 0 to 35. Even when the absolute values of the gel fraction differences are each more than 50, the resultant foamability can be improved by increasing the number of radiations of the ionizing radial ray, using plural polyfunctional monomer species as organic peroxides, or adjusting the temperature for the crosslinking.

### 1-2-8. Form of Crosslinked Foam Layer (B)

The thickness of the crosslinked foam layer (B) obtained using the material for forming the crosslinked foam layer (B) is preferably in the range from 1.0 to 3.0 mm. When the thickness is in this range, a high shapability can be obtained in vacuum molding and further a sufficient strength can be obtained. In particular, a high resistance against scratching, sticking and the like can be obtained so that characteristics suitable for an interior material article for an automobile can be obtained. The thickness thereof is more preferably from 1.2 to 2.8 mm, and further preferably from 1.3 to 2.7 mm.

The foaming state of the crosslinked foam layer (B) is not particularly limited. The density thereof (foamed body density) is preferably in the range from 20 to 140 kg/m³. When the density is in the above range, the crosslinked foam layer (B) can lead to an interior material article for an automobile having lightness and sufficient cushioning property, even if the layer (B) is thin. Additionally, while the content ratio of the polylactic acid-based resin (b1) is made high, the crosslinked foam layer (B) can lead to an interior material article for an automobile excellent in external appearance, touch sensitivity, oil resistance and humidity-based-ageing resistance. The density is more preferably from 30 to 120 kg/m³, and further preferably from 45 to 100 kg/m³. The measurement of the density is according to JIS K 6767 (Foamed-Plastic/Polyethylene Test Method).

### 1-3. Base Layer (C)

The base layer (C) is a layer for supporting the skin layer (A) and the crosslinked foam layer (B) (see a layer 13 in FIG. 1). A material for forming the base layer (C) is not particularly limited and is usually a material having thermoplasticity to the base layer (C) as a whole. Accordingly, the base layer (C) usually comprises a thermoplastic resin.

The thermoplastic resin capable of constituting the base layer (C) is not particularly limited and example thereof includes a polyolefin-based resin, a polyester resin, polystyrene, an acrylic resin (resin obtained using methacrylate and/or acrylate), a polyamide resin, a polycarbonate resin, polyacetal resin, an ABS resin such as a resin of methyl methacrylate, acrylonitrile, butadiene and styrene, an MBS resin such as a resin of methyl methacrylate, butadiene and styrene, and the like. These resins may be contained singly or in combination of two or more types thereof.

Examples of the polyolefin-based resin include polypropylene, polyethylene, ethylene-propylene copolymer such as ethylene-propylene block copolymer, ethylene-propylene random copolymer and ethylene-propylene rubber, and the like. Other examples include all the resins given as the examples of the polyolefin-based resin (a1) constituting the skin layer (A), and the polyolefin-based resin (b2) contained in the crosslinking and foaming resin composition for the crosslinked foam layer (B). The polyolefin-based resin may be used singly or in combination of two or more types thereof. The polyolefin-based resin for the base layer (C) may be the same as or different from the polyolefin-based resin (a1) in the skin layer (A) above. In addition, the polyolefin-based resin for the base layer (C) may be the same as or different from the polyolefin-based resin (b2) in the crosslinked foam layer (B) above.

Examples of the polyester resin include an aliphatic polyester resin, an aromatic polyester resin, a cellulose-based polyester and the like. These resins may be used singly or in combination of two or more types thereof.

Examples of the aliphatic polyester resin include a polylactic acid-based resin, polyethylene succinate, polybutylene succinate, polybutylene succinate-adipate, polybutylene succinate-carbonate and the like. These resins may be used singly or in combination of two or more types thereof. Examples of the polylactic acid-based resin include all the resins given as the examples of the polylactic acid-based resin (b1) contained in the crosslinking and foaming resin composition forming the crosslinked foam layer (B) above. The polylactic acid-based resin constituting the base layer (C) may be the same as or different from the polylactic acid-based resin (b1) contained in the crosslinking and foaming resin composition forming the crosslinked foam layer (B).

Examples of the aromatic polyester resin include polyethylene terephthalate, polytrimethylene terephthalate, polybutylene terephthalate and the like. These resins may be used singly or in combination of two or more types thereof.

Examples of the cellulose-based polyester resin (biodegradable cellulose ester) include cellulose acetate, cellulose butyrate, cellulose propionate, cellulose nitrate, cellulose sulfate, cellulose acetate butyrate, cellulose nitrate acetate and the like. These resins may be used singly or in combination of two or more types thereof.

Further, examples of the above-mentioned acrylic resin include polyacrylonitrile, poly methyl methacrylate and the like. These resins may be used singly or in combination of two or more types thereof.

Examples of the polyamide resin include poly caprolactam (nylon 6), poly hexamethylene diamide (nylon 66) and the like. These resins may be used singly or in combination of two or more types thereof.

Other examples of the thermoplastic resin include a polypeptide such as polyglutamic acid, polyaspartic acid and polyleucine, poly vinyl alcohol, poly vinyl acetate, poly vinyl chloride and the like. These resins may be used singly or in combination of two or more types thereof.

Of these thermoplastic resins, a polylactic acid-based resin and a cellulose-based polyester resin are preferred since the resins lead to biodegradability and further a natural material may be used as a raw material so that the resins exhibit excellent environmental properties. Particularly, a polylactic acid-based resin is preferred since the resin leads to excellent mechanical properties, endurance and other performances.

In the case where a polylactic acid-based resin is used for the base layer (C), the molecular weight and molecular weight distribution thereof are not particularly limited. The lower limit of the weight-average molecular weight thereof is preferably 10,000 or more. On the other hand, the upper limit thereof is preferably 800,000 or less. When the molecular weight is in the above range, excellent mechanical properties can be obtained in the resultant base layer (C). The lower limit thereof is more preferably 50,000 or more, and further preferably 100,000 or more. On the other hand, the upper limit thereof is more preferably 600,000 or less, and further preferably 400,000 or less. The weight-average molecular weight is measured by gel permeation chromatography (GPC) using hexafluoroisopropanol as a solvent, and is a molecular weight in terms of poly methyl methacrylate (PMMA).

The concentration of the terminated carboxyl group in the polylactic acid-based resin for the base layer (C) is not particularly limited and is preferably 20 or less equivalents per ton. When the concentration thereof is in the above range, the hydrolysis of the polylactic acid-based resin is restrained so that an excellent ageing resistance can be obtained in the resultant base layer (C) (in particular, the bending strength can be effectively maintained at high temperature and high humidity). The concentration is more preferably from 0 to 15 equivalents per ton and further preferably from 0 to 10 equivalents per ton. The concentration of the terminated carboxyl group is the same as that of the above-mentioned polylactic acid-based resin (b1). And the method for controlling the concentration of the terminated carboxyl group is also the same.

The base layer (C) may comprise an organic natural material together with the above-mentioned thermoplastic resin. The organic natural material is an organic component made of a natural material, and example thereof includes a natural fiber, a non-fibrous plant material and the like. Examples of the natural fiber include a plant fiber, a protein fiber such as animal hair fiber and silk fiber, and the like. Of these materials, a plant fiber and non-fibrous plant material are preferred.

The plant fiber is a fiber originating from a plant, and is also called cellulose fiber. Examples of the plant fiber include ones obtained by a plant such as kenaf, jute hemp, manila hemp, sisal hemp, gampi, Mitsumata, Kozo, banana, pineapple, coconut, corn, sugarcane, bagasse, palm, papyrus, reed grass, esparto, Sabi grass, oat, rice plant, bamboo, various conifer trees (Japanese cedar, Japanese cypress, and others), broad leaf tree and cotton. The plant fiber may be used singly or in combination of two or more types thereof.

The moiety of a plant that is used for the plant fiber is not particularly limited, but may be any moiety that constitutes the plant as far as the fiber can be collected therefrom; examples of the moiety include a non-woody moiety, a stalk moiety, a root moiety, a leaf moiety and a woody moiety. Accordingly, fibers collected from the individual moieties are a bast fiber (derived from kenaf, roselle, Cannabis Sativa, flax, ramie, jute, hemp and the like), a seed hair fiber (derived from cotton and the like), a leaf vein fiber (derived from Manila hemp, sisal hemp and the like), a fruit fiber (derived from coconut and the like), and the like. Only a specified moiety may be used, or two or more different moieties may be used in combination. Other examples of the plant fiber include a pulp such as gramineous pulp and woody pulp. These may be used singly or in combination of two or more types thereof.

The above-mentioned non-fibrous plant material may be any material obtained by subdividing woody moieties of a plant, such as a woody-moiety-crushed product or a woody-moiety-pulverized product. More specifically, the non-fibrous plant material may be a kenaf core, woody flour, and the like. These may be used singly or in combination of two or more types thereof.

Among these plants, the kenaf is particularly preferred. The kenaf is a very fast growing annual grass and has excellent absorbitity of carbon dioxide so that it can contribute to reducing an amount of carbon dioxide in the air, thus effectively utilizing forest resources and others. The tough skin of kenaf contains cellulose components in a proportion of 60% or more; thus, kenaf fiber collected from the tough skin of the kenaf is particularly preferred.

The kenaf according to the invention is an early growing annual plant having a woody stem and is classified into malvaceae. The kenaf includes hibiscus cannabinus and hibiscus sabdariffa of scientific names, and further includes Indian hemp, Cuban kenaf, kenaf, roselle, mesta, bimli hemp, ambary hemp, Bombay hemp and the like of common names.

The jute according to the invention is a fiber obtained from jute hemp. Examples of the jute hemp include Corchorus capsularis L., Corchorus olitorius, moloheiya, and other plants of the hemp family and the linden family.

The average fiber length and the average fiber diameter of the natural fiber (in particular, a plant fiber) are not particularly limited. The average fiber length is preferably 10 mm or more. When the plant fiber having the above average fiber length is used, the base layer (C) exhibits excellent mechanical properties. The average fiber length is more preferably in the range from 10 to 150 mm, further preferably from 20 to 100 mm, and particularly from 30 to 80 mm. The average fiber length is the average of values obtained by taking out monofilaments one by one at random from the fiber, keeping the taken-out monofilaments straightly without extending the monofilaments, and measuring the lengths of the total 200 of the monofilaments on a spread-flat measure by the direct method in accordance with JIS L 1015.

The average fiber diameter is preferably 1 mm or less. When the plant fiber having the above average fiber diameter, the base layer (C) exhibits excellent mechanical properties. The average fiber diameter is more preferably in the range from 0.01 to 1 mm, further preferably from 0.05 to 0.7 mm, and particularly from 0.07 to 0.5 mm. The average fiber diameter is the average of values obtained by taking out monofilaments one by one at random from the fiber, and using an optical microscope to measure actually the fiber diameter at the center in the length direction of each of the total 200 of the monofilaments.

These organic natural materials may each be subjected to pretreatment with a coupling agent having a reactive functional group, or the like in order to improve in the affinity with the thermoplastic resin used together, and others. Examples of the coupling agent include an isocyanate based compound, an organic silane based compound, an organic titanate based compound and the like.

When a thermoplastic resin and a natural fiber are used together for the base layer (C) as described above, the content ratio is not particularly limited. The content of the thermoplastic resin may be set into a range from 1% to 99% by weight, preferably from 3% to 97% by weight, and particularly from 5% to 95% by weight based on 100% by weight of the total of the thermoplastic resin and the natural fiber. In the case of using, in particular, a polylactic acid-based resin as the thermoplastic resin and kenaf fiber as the natural fiber, the content of the polylactic acid-based resin may be set into a range from 10% to 90% by weight, preferably from 20% to 80% by weight, and particularly from 30% to 70% by weight based on 100% by weight of the total of the polylactic acid-based resin and the kenaf fiber. Additionally, in the case of using a polypropylene-based resin as the thermoplastic resin and kenaf fiber as the natural fiber, the content of the polypropylene-based resin may be set into a range from 10% and 90% by weight, preferably from 20% to 80% by weight, and particularly from 30% to 70% by weight based on 100% by weight of the total of the polypropylene-based resin and the kenaf fiber.

The thickness of the base layer (C) is not particularly limited, but is preferably 10 mm or less. The base layer (C) having the above thickness can have a high moldability by vacuum molding and lead to a strength sufficient for being used in an interior material article for an automobile while this layer supports the other layers. The thickness thereof is more preferably in the range from 0.1 to 5.0 mm, and further preferably from 1.0 to 3.0 mm.

The density of the base layer (C) is not particularly limited, but is usually 1.5 g/cm³ or less and is preferably 0.3 g/cm³ or more, in particular, when the base layer (C) is composed of a thermoplastic resin and a plant fiber. When the density thereof is in the above range, the base layer (C) can have sufficient mechanical properties necessary for an interior material article for an automobile. In particular, in order to obtain an excellent bending strength of the article when the layer (C) is used in an interior material article for an automobile, the density is preferably in the range from 0.4 to 1.4 g/cm³, and especially from 0.6 to 1.3 g/cm³. In the case of using, in particular, a polylactic acid-based resin as the thermoplastic resin and kenaf fiber as the plant fiber, the density is preferably in the range from 0.4 to 1.0 g/cm³, more preferably in the range from 0.5 to 0.9 g/cm3, and especially from 0.6 to 0.8 g/cm³ for the same reason.

The density which is an apparent density is a density of the base layer (C) after the layer in the interior material article for an automobile is allowed to stand still under a standard condition of temperature of 20° C. and relative humidity of 65% for 24 hours, and is a value obtained by making a measurement in accordance with JIS K 7112 (Method for Measuring the Density and the Specific Gravity of Plastic/Non-foamed-Plastic).

In connection with other properties of the base layer (C), the initial value of the bending strength thereof is preferably 20 MPa or higher, more preferably in the range from 20 to 50 MPa, and further preferably from 25 to 40 MPa. This bending strength is the bending strength obtained by allowing a test piece (in the form of a rectangular plate of 4 mm in thickness, 10 mm in width and 80 mm in length) to stand still under a standard condition of temperature of 20° C. and relative humidity of 65% for 24 hours, and then making a measurement when the test piece is supported at two supporting points (distance (L) therebetween: 64 mm, and curvature radius: 5 mm) while a load was given onto the piece at a rate of 2 mm/minute from an action point (curvature radius: 5 mm) arranged at the center between the supporting points (in accordance with JIS K 7171). The obtained bending strength is defined as the initial value thereof.

In the base layer (C), the retention ratio of the bending strength after the test piece is allowed to stand still at a high temperature of 50° C. and a high relative humidity of 95% for 1,200 hours to the initial value is preferably 20% or higher, more preferably in the range from 30% to 70%, and further preferably from 40% to 60%.

In FIG. 1 showing an example of the interior material article for an automobile of the present invention, the base layer (C) 13 comprises a thermoplastic resin part 132 and a natural fiber 131 that is dispersed in the thermoplastic resin part 132. The thermoplastic resin part 131 in the base layer (C) 13 may bind natural fibers 131 and have gas permeability in cross-sectional direction.

The material for forming the base layer (C) may be a base layer yielded by any method.

For example, the material for forming the base layer (C) may be yielded by the following methods (1) to (4):

(1) A fibrous thermoplastic resin wherein a thermoplastic resin is made into a fibrous form is used; the resin fiber and a natural fiber are made into a filament-mixed state (in a manner of depositing the fibers simultaneously in an airlaying method or in some other manner) to yield a mat-form product; and then the resultant mat-form product is subjected to heating and compressing;

(2) A liquid dispersion wherein a thermoplastic resin is dispersed in a liquid (the dispersion state thereof is not particularly limited, and may be an emulsion state, a suspension state or the like) is sprayed onto a natural fiber to yield a resin-mixed fiber; the fiber is heated and dried; the resin-mixed fibers were deposited in an airlaying method or in some other manner to yield a mat-form product; and the resultant mat-form product is subjected to heating and compressing;

(3) A mat-form product wherein only a natural fiber is made into a nonwoven cloth is immersed into a liquid dispersion wherein a thermoplastic resin is dispersed in a liquid (the dispersion state thereof is not particularly limited, and may be an emulsion state, a suspension state or the like); this is dried; and the resultant mat-form product is subjected to heating and compressing; and

(4) A powdery thermoplastic resin wherein a thermoplastic resin is made into a powder form is used; the resin powder is mixed with a natural fiber (in a manner of depositing the resin and the fiber simultaneously in an airlaying method, in a manner of kneading them, or in some other manner); the resultant resin-mixed fiber is heated to melt-bond the resin onto the natural fiber; and the resultant mat-form product is subjected to heating and compressing.

Any one of these methods (1) to (4) may be used, and a method other than these methods may be used. These methods may be used singly or in combination of two or more types thereof.

Of these methods, from a viewpoint that the natural fiber and the thermoplastic resin are dispersed into an evener state in the resultant material for forming the base layer (C) in mat-form, the method (2) or (3) is preferred. In addition, from a viewpoint that the process is simple for weight production, costs for the production can be held down, and a high productivity can be obtained, the method (1) is preferred. Among these, the method (1) is especially preferred.

The filament-mixing method using the natural fiber and the thermoplastic resin fiber is not particularly limited. For example, airlaying method, fleecing method, carding method and the like may be used. These methods may be used singly or in combination of two or more types thereof. After filament-mixing, entangling the mixed fibers may be conducted. The entangling method is not particularly limited and may include a needle punching, a stitch bonding and the like. These methods may be used singly or in combination of two or more types thereof. When the non-heated mat-form product obtained above is subjected to heating and compressing, the heating temperature and the applying pressure may be set, for example, into the range from 170° C. to 240° C. and the range from 10 to 20 kgf/cm², respectively.

### 1-4. Other Layer

The interior material article for an automobile of the present invention may be provided with other layer in addition to the skin layer (A), the crosslinked foam layer (B) and the base layer (C). Examples of the other layer include a felt layer for improving the sound absorbency, a polyurethane layer for improving the impact resistance, an adhesive layer for joining any two of the layers to each other, and the like. Other layer may be provided singly or in combination of two or more types thereof.

In the interior material article for an automobile of the present invention, it is preferred that the modified polyolefin (b3) is a copolymer of a monomer selected from the group consisting of a vinyl ester of a carboxylic acid and an ester of a (meth)acrylic acid, and an olefin. According to this embodiment, the amount of the polylactic acid-based resin (b1) that can be incorporated into the crosslinked foam layer (B) can be made large so that the effect of reducing environmental loading can be further improved.

In the interior material article for an automobile of the present invention, it is preferred that the polyolefin-based resin (b2) comprises a polypropylene-based resin (b21) and a polyethylene-based resin (b22), the polypropylene-based resin (b21) is an ethylene-propylene copolymer containing a monomer unit based on ethylene in an amount of 25% or less by mole, the polyethylene-based resin (b22) is at least one of a polyethylene and a copolymer containing a monomer unit based on ethylene in an amount of 70% or more by mole, and the content of the polypropylene-based resin (b21) is 10% or more by weight based on 100% by weight of the total of the polypropylene-based resin (b21) and the polyethylene-based resin (b22) that are contained in the polyolefin-based resin (b2). According to this embodiment, the amount of the polylactic acid-based resin (b1) that can be incorporated into the crosslinked foam layer (B) is made large while the cushioning property and the moisture-based-ageing resistance can be made consistent with each other at a particularly high level.

In the interior material article for an automobile of the present invention, it is preferred that the base layer (C) comprises a polylactic acid-based resin and a natural fiber. According to this embodiment, it is unnecessary to make separately an air-absorbing hole for coping with vacuum molding in the base layer (C); therefore, the production process of the interior material article for an automobile can be made simpler, and the material can be more effectively produced at low costs. Additionally, the material can be rendered an interior material article for an automobile light and particularly high in the effect of reducing environmental loading.

In the interior material article for an automobile of the present invention, it is preferred that the base layer (C) comprises a polyolefin-based resin and a natural fiber. According to this embodiment, it is unnecessary to make separately an air-absorbing hole for coping with vacuum molding in the base layer (C); therefore, the production process of the interior material article for an automobile can be made simpler, and the material can be more effectively produced at low costs. Additionally, the material can be rendered an interior material article for an automobile light and particularly high in the effect of reducing environmental loading.

In the interior material article for an automobile of the present invention, it is preferred that the skin layer (A) has a concave-convex pattern by die forming. According to this embodiment, the interior material article for an automobile has excellent cushioning property, oil resistance and moisture-based-ageing resistance while the material can gain especially high external appearance and touch sensitivity.

In the interior material article for an automobile of the present invention, it is preferred that the ratio of a thickness t_{A} of the skin layer (A) to a thickness t_{B} of the crosslinked foam layer (B) is in the range from 0.05 to 1.0. According to this embodiment, the laminated sheet keeps moldabilities in vacuum molding, in particular, the property of following the form of the base layer (C) at a high level while the interior material article for an automobile can gain excellent cushioning property, oil resistance, moisture-based ageing resistance and the like. Furthermore, the excellent external appearance and touch sensitivity can be obtained.

### 2. Production Method of Interior Material Article for Automobile

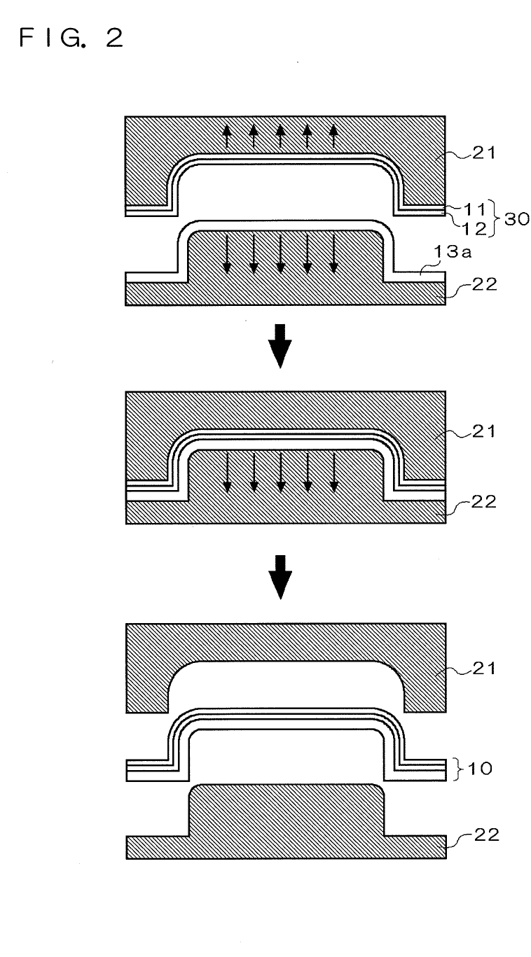

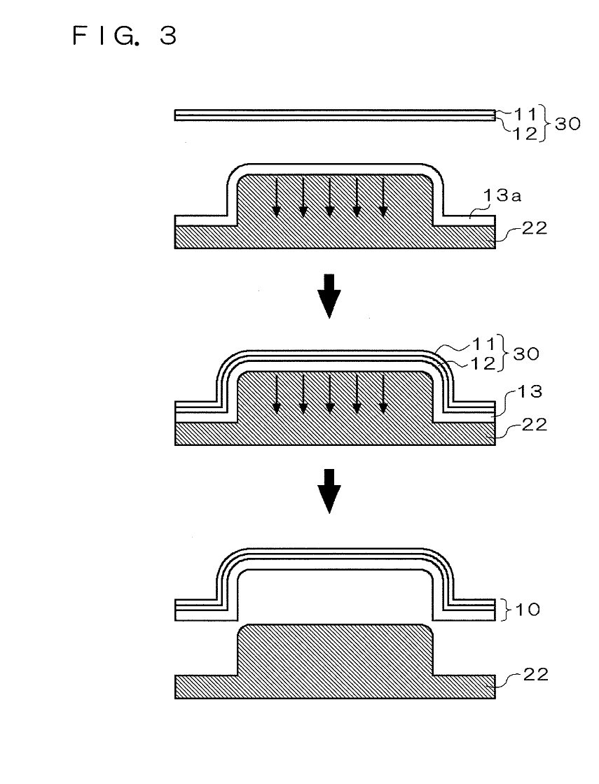

The interior material article for an automobile of the present invention is a material in which a laminated sheet 30 consisting of the skin layer (A) and the crosslinked foam layer (B) and a material 13a for forming the base layer (C) are subjected to vacuum molding (see FIGS. 2 and 3) so as to be integrated into a single unit facing the crosslinked foam layer (B) 12 of the laminated sheet 30 and the base layer (C) 13.

The production method of the laminated sheet is not particularly limited. Examples of the method for the production include: (1) a method of subjecting a material for forming the skin layer (A) and a material for forming the crosslinked foam layer (B) to adhesion onto each other using an adhesive agent such as a polyurethane-based adhesive agent and a poly vinyl acetate-based emulsion; (2) a method of subjecting a material for forming the skin layer (A) and a material for forming the crosslinked foam layer (B) to adhesion onto each other using an adhesive member such as a hot melt film; (3) a method of heating a surface of a material for forming the skin layer (A) and/or a surface of a material for forming the crosslinked foam layer (B), facing heated surfaces to press, thereby joining to form the layers (A) and (B) to be integrated; and (4) a method of extruding, from an extruder, a resin composition which is to be the skin layer (A) into a sheet form onto a surface of a material for forming the crosslinked foam layer (B), thereby forming the laminated sheet in which the layers (A) and (B) are joined.

Any one of these methods (1) to (4) may be used, and a method other than these methods may be used. Further, the method may be used singly or in combination of two or more types thereof.

As described above, the skin layer (A) may have, on its surface (a surface which is to be a design surface when the layer becomes a part of the interior material article for an automobile), a concave-convex pattern. This concave-convex pattern may be formed at any time. Specifically, the pattern may be formed, for example, (1) at the same time when a material for forming the skin layer (A) is formed, (2) at the time when the laminated sheet is formed, or (3) at the time when vacuum molding, which will be detailed below, is conducted.

The vacuum molding according to the present invention means a method using suction to join the laminated sheet and a material for forming the base layer (C). The method for vacuum molding is not particularly limited as far as a molded article can be obtained using suction. For example, a method of joining the pre-heated laminated sheet and a material for forming the base layer (C) that is pre-molded beforehand into a desired shape at the same time when vacuuming is conducted. In such vacuum molding, a male mold vacuum-drawing molding, a female mold vacuum-drawing molding, a vacuum molding using both of these drawings, a method of molding a material by use of a plug assist or the like at the same time when a male mold vacuum-drawing molding is conducted, a vacuum molding of conducting vacuum-drawing at the same time when a material is pressed by means of upper and lower mold parts, and other methods may be applied.

More specifically, the above-mentioned vacuum molding may be, for example, vacuum molding illustrated in FIGS. 2 and 3.

The vacuum molding illustrated in FIG. 2 is described. First, a laminated sheet 30 is subjected to sucking to be closed to an upper mold part 21 for vacuum molding by the skin layer (A) 11 side, on the other hand, a material for forming the base layer (C) 13a is placed on a lower mold part 22 for vacuum molding; fastening the upper mold part 21 for vacuum molding and the lower mold part 22 for vacuum molding to each other; sucking the material for the base layer (C) 13a through the lower mold part 22 for vacuum molding so as to integrate the laminated sheet 30 and the material for forming the base layer (C) 13a into a single unit, thereby yielding an interior material article for an automobile 10; and then releasing the material article 10. In the integration into the single unit, there are a method with an adhesive agent, a method with an adhesive member and a method with heating and compressing, and the method can be selected from them. In other words, they are, (1) a method in which the skin layer (A) in the laminated sheet and the material for forming the base layer (C) are joined using an adhesive agent such as a polyurethane-based adhesive agent and a poly vinyl acetate-based emulsion, (2) a method in which the skin layer (A) in the laminated sheet and the material for forming the base layer (C) are joined using an adhesive member such as a hot melt film, and (3) a method including heating a surface of the skin layer (A) in the laminated sheet and/or a surface of a material for forming the base layer (C), facing heated surfaces, and pressing.

When the mold parts are fastened to each other, (1) both of sucking through the upper mold part 21 and that through the lower mold part 22 may be cancelled, or (2) sucking through the upper mold part 21 may be cancelled while the sucking through the lower mold part 22 is kept as it is. In the case where a material for forming the base layer (C) 13a has gas permeability in particular, the use of the method (2) makes it possible to improve the property of following the form of the laminated sheet 30 and to join the laminated sheet 30 and the material for forming the base layer (C) 13a with a higher certainty.

If the material for forming the base layer (C) 13a contains no natural fiber, through holes for gas permeability can be formed in the material for forming the base layer (C) by a predetermined processing. In the case where the material for forming the base layer (C) contains a natural fiber, the content of a thermoplastic resin of 70% or less by weight based on 100% by weight of the total of the thermoplastic resin and the natural fiber leads to gas permeability in the material for forming the base layer (C) 13a and the gas permeability can be used for vacuum molding.

When the concave-convex pattern is formed in vacuum molding, the pattern can be transferred using an upper mold part 21 for vacuum molding having a convex-concave pattern on its inner surface to form. The transferring of the concave-convex pattern may be conducted at any stage. When the upper mold part 21 is rendered, for example, a heating mold part, the transferring can be attained by facing and sucking the skin layer (A) of the laminated sheet 30 onto the upper mold part 21. Additionally, when the laminated sheet 30 and a material for forming the base layer (C) 13a are pressed by the upper mold part 21 and the lower mold part 22 (i.e., the mold parts are fastened), the transferring may also be conducted.

When the concave-convex pattern is transferred onto the surface of the skin layer (A), it is preferred to heat the design surface of the skin layer (A) to a temperature of 150° C. or higher. The above temperature leads to a vivid pattern for concave-convex. The heating temperature is preferably in the range from 160° C. to 220° C., and further preferably from 180° C. to 200° C.

The material for forming the base layer (C) 13a may be pre-shaped or heated so as to have plasticity before the material is subjected to sucking to the lower mold part 22 for vacuum molding.

Next, the vacuum molding illustrated in FIG. 3 is described. A material for forming the base layer (C) 13a is placed on a mold 22, and then a laminated sheet 30 heated so as to have plasticity is set to the material 13a by the crosslinked foam layer (B) of the laminated sheet. Heating temperature for plasticity is preferably in the range from 120° C. to 160° C. Subsequently, the laminate is subjected to sucking through the mold 22 to integrate the laminated sheet 30 and the material for forming the base layer (C) 13a into a single unit for an interior material article for an automobile 10. After that, the resultant interior material article for an automobile 10 is released from the mold 22. In the integration into the single unit, there are a method with an adhesive agent, a method with an adhesive member and a method with heating and compressing, and the method can be selected from them. In other words, they are, (1) a method in which the skin layer (A) in the laminated sheet and the material for forming the base layer (C) are joined using an adhesive agent such as a polyurethane-based adhesive agent and a poly vinyl acetate-based emulsion, and (2) a method in which the skin layer (A) in the laminated sheet and the material for forming the base layer (C) are joined using an adhesive member such as a hot melt film.

In the case where a material for forming the base layer (C) 13a has gas permeability in particular, sucking of the materials through the mold 22 makes it possible to improve the property of following the form of the laminated sheet 30 and to join the laminated sheet 30 and the material for forming the base layer (C) 13a with a higher certainty.

If the material for forming the base layer (C) contains no natural fiber, through holes for gas permeability can be formed in the material for forming the base layer (C) by a predetermined processing. In the case where the material for forming the base layer (C) contains a natural fiber, the content of a thermoplastic resin of 70% or less by weight based on 100% by weight of the total of the thermoplastic resin and the natural fiber leads to gas permeability in the material for forming the base layer (C) and the gas permeability can be used for vacuum molding.

The material for forming the base layer (C) 13a is usually pre-shaped before placing on the mold 22. If the material is not pre-shaped, a material for forming the base layer (C) obtained by heating so as to have plasticity may be placed on the mold 22 to be sucked for molding.

When vacuum molding is applied, the laminated sheet 30 is preferably heated by any method other than the methods illustrated in FIGS. 2 and 3. This makes it possible to restrain a local elongation of the laminated sheet 30 and obtain an excellent property of following a complicated shape. The heating temperature of the laminated sheet is not particularly limited, and is preferably set to an appropriate temperature in accordance with the forming material and the thickness of the skin layer (A), the forming material and the thickness of the crosslinked foam layer (B), and others. Heating is conducted so as to set the temperature of the design surface of the skin layer (A) into the range preferably from 100° C. to 220° C., more preferably from 120° C. to 200° C., and further preferably from 140° C. to 180° C. After that, the temperature may be maintained. When the temperature is set in the above range, a laminated sheet 30 and a material for forming the base layer (C) 13a can be joined by vacuum molding while maintaining a sufficient bonding strength between the skin layer (A) and the crosslinked foam layer (B) to form an interior material article for an automobile excellent in external appearance.

The interior material article for an automobile of the present invention is used as an interior material article for an automobile. The article is suitable for various moieties such as a door, an instrument panel, a pillar, a sun visor, a sheet back garnish, a console box, a ceil, a floor, a package tray, a switch base, a quarter panel, an arm rest, a dashboard and a deck trim.

### Example

Hereinafter, the invention will be more specifically described by way of Examples. The present invention is in no way limited by these Examples.

### 1. Starting Material for Interior Material Article for Automobile

Prepared were a forming material for a skin layer (A), a forming material for a crosslinked foam layer (B) and a forming material for a base layer (C) described below.

### 1-1. Forming Material for Skin Layer (A)

An olefin-based elastomer sheet (trade name: “TPO SHEET”, manufactured by Kyowa Leather Cloth Co., Ltd.) was used. This sheet is made of a polyolefin-based resin (a1) yielded by melt-mixing an olefin-based thermoplastic elastomer with a polyolefin consisting of a copolymer of ethylene and propylene, and has a thickness of 0.5 mm, and Shore A hardness of 80.

### 1-2. Forming Material for Crosslinked Foam Layer (B)

Following components were used at respective blend ratios shown in Table 1 and subjected to mixing by use of a biaxial extruder of 60 mm in diameter to yield sheet-form products each made of crosslinking and foaming resin composition. Thereafter, the sheet-form products were each irradiated with ionizing radial rays at an acceleration voltage of 800 kV and a dose of 100 kGy, so as to be crosslinked. Subsequently, the crosslinked sheet-form products were continuously charged into a vertical hot-wind foaming furnace, the temperature of which was set to a temperature of 240° C., so as to generate foams for about 3 to 5 minutes. In this way, sheets (B1) to (B8) having a thickness of about 1.2 mm were produced.

When the total amount of the polylactic acid-based resin (b1), the polyolefin-based resin (b2) and the modified polyolefin (b3) was regarded as 100 parts by weight, the crosslinking aid (b4) and the foaming agent (b5) were used in amounts of 4 parts by weight and 5 parts by weight, respectively, in an externally blending manner.

1-2-1. Polylactic Acid-Based Resin (b1)

Polylactic acid (trade name “4042D”, manufactured by Naturewax) was used. The resin has a d-body unit content of 3.9% by mole, a concentration of the terminated carboxyl group of 25 equivalents per ton and a weight-average molecular weight of 180,000.

1-2-2. Polyolefin-Based Resin (b2)
(1) Polypropylene-Based Resin (b21)

Ethylene-propylene random copolymer (trade name “EG60”, manufactured by Japan Polypropylene Corp.) was used. The resin has an ethylene unit of 4.5% by weight, a weight-average molecular weight of 300,000, and an MFR (230° C.) of 1.8 g/10-minutes.

(2) Polyethylene-Based Resin (b22)

Linear low density polyethylene (trade name “SJ860G”, manufactured by Japan Polyethylene Corp.) was used. The resin is an ethylene-1-hexene copolymer having an ethylene unit of 70% or more by mole and has a weight-average molecular weight of 250,000, and an MFR (190° C.) of 2.0 g/10-minutes.

1-2-3. Modified Polyolefin (b3)

Ethylene-vinyl acetate copolymer (trade name “EV460”, manufactured by Du Pont-Mitsui Polychemicals Co., Ltd.) was used. The resin has a weight-average molecular weight of 200,000 and an MFR (190° C.) of 2.5 g/10-minutes.

1-2-4. Crosslinking Aid (b4)

Divinylbenzene was used.

1-2-5. Foaming Agent (b5)

Azodicarbonamide was used.

TABLE 1

| | | Crosslinking and foaming resin composition | | | | | | | |
|---|---|---|---|---|---|---|---|---|---|
| | | | Polyolefin-based resin (b2) | | | | | | |
| | | Polylactic | Polypropylene- | Polyethylene- | Modified | | Foaming | | |
| | | acid-based | based resin | based resin | polyolefin | Crosslinking | agent | b21/ | Density |
| | | resin (b1) | (b21) | (b22) | (b3) | aid (b4) | (b5) | (b21 + b22) | (kg/m³) |
| Forming material | B1 | 20 | 50 | 25 | 5 | 4 | 5 | 67 | 84 |
| for crosslinked | B2 | 20 | 75 | 0 | 5 | 4 | 5 | 100 | 84 |
| foam layer (B) | B3 * | 40 * | 40 * | 15 | 5 | 4 | 5 | 73 | 80 |
| | B4 * | 20 | 50 | 30 | 0 * | 4 | 5 | 63 | 85 |
| | B5 * | 20 | 50 | 15 | 15 * | 4 | 5 | 77 | 82 |
| | B6 | 20 | 5 | 70 | 5 | 4 | 5 | 7 | 80 |
| | B7 | 25 | 47 | 23 | 5 | 4 | 5 | 67 | 84 |
| | B8 | 20 | 53 | 25 | 2 | 4 | 5 | 68 | 82 |

In Table 1, the symbols “*” each represent an item (material type or amount) outside the scope or the range specified in the invention.

### 1-3. Forming Material for Base Layer (C)

### (1) Forming Material for Base Layer C1

Kenaf fiber (natural fiber) cut into a length of 70 mm, and polylactic acid fiber (obtained by melt-spinning polylactic acid pellets having an L body unit content of 95% by mole and a weight-average molecular weight of 110,000 to 130,000 at Toyota Boshoku Corp.) into a length of 51 mm were made into a filament-mixed state, and then made into laminated layers in an airlay way, so as to yield a web. Thereafter, two webs formed were confounded with each other with a needle punch to form a mat. This mat contained the kenaf fiber and the polylactic acid fiber at a weight ratio of 50/50. Next, the mat was subjected to heating and pressing at a pressure of 10 kg/cm² until the internal temperature turned to 210° C. by use of a hot plate heated to a temperature of 235° C. Thereafter, the mat was cooled to ambient temperature to yield a board having a thickness of 2.5 mm. This board was heated with a hot wind oven heated to a temperature of 235° C. until the internal temperature turned to 210° C. Subsequently, the board was cold-pressed into an interior material article for an automobile door-lining shape (maximum deep-drawing depth: 80 mm) at a pressure of 20 kg/cm². This was used as a forming material for base layer C1. The thickness of the forming material for base layer C1 was 2.3 mm.

### (2) Forming Material for Base Layer C2

A board was yielded in the same way as the above-mentioned forming material for base layer C1 except that polypropylene fiber (obtained by subjecting to melt-spinning a product available as trade name “NOVATEC SA01”manufactured by Japan Polypropylene Corp. at Toyota Boshoku Corp.) was used instead of the polylactic fiber. This board was used as a forming material for base layer C2. The thickness of the forming material for base layer C2 was 2.3 mm.

### (3) Forming Material for Base Layer C3

Only an ABS resin (trade name “MUH E7301”, manufactured by Techono Polymer Co., Ltd.) was injection-molded into the almost same size and same shape as the above-mentioned forming material for base layer C1. This board was used as a forming material for base layer C3. The thickness of the forming material for base layer C3 was 2.5 mm.

### 2. Production and Evaluation of Interior Material Article for Automobile

### Examples 1 to 7 and Comparative Examples 1 to 3

Forming material for the skin layer (A), forming material for the crosslinked foam layer (B) and forming materials for the base layer (C) were used in respective combinations shown in Table 2 to yield interior material articles for automobile each having three layers.

One of both sides of the forming material for the skin layer (A) was heated to 180° C. Separately, one of both sides of the forming material for the crosslinked foam layer (B) was heated to 120° C. Thereafter, the heated surfaces were brought into contact with each other, and the two were bonded to each other under pressure to yield a laminated sheet 30.

Next, the laminated sheet 30 was heated until the surface temperature of the skin layer (A) 11 side of the laminated sheet turned to 180° C. Thereafter, the vacuum molding illustrated in FIG. 2 was used and the laminated sheet 30 was sucked through the upper mold part 21 for vacuum molding (having, on its surface, a formed skin grain pattern for transferring) to transfer the skin grain pattern onto the surface of the skin layer (A) 11. Subsequently, the lower mold part 22 and the upper mold part 21 for vacuum molding were fastened to each other so as to press the forming material for the base layer (C) 13 held in the lower mold part 22 and the laminated sheet 30 held in the upper mold part 21 for vacuum molding, thereby bonding them to each other. As a result, an interior material article for an automobile 10 was obtained. The resultant interior material articles for an automobile according to Examples 1 to 3 and 5 to 7 and Comparative Examples 1 to 3 had the skin layer (A), crosslinked foam layer (B) and base layer (C) in widths of 0.4 mm, 1.0 mm and 2.3 mm, respectively. And the resultant interior material article for an automobile according to Example 4 had the skin layer (A), crosslinked foam layer (B) and base layer (C) in widths of 0.4 mm, 1.0 mm and 2.5 mm, respectively.

The resultant interior material articles for an automobile were evaluated.

### (1) Moldability

The interior material article for an automobile was subjected to a visual inspection at the design surface side (skin layer (A) side) thereof to observe whether or not peeling-off was generated between the skin layer (A) and the crosslinked foam layer (B), and whether or not a lack of hiding at the skin layer (A) based on the concave-convex form of the base layer (C) was generated. The results were judged in accordance with the following criteria, and shown in Table 2:

“◯”; peeling-off and lack of hiding were not observed, and

“×”; at least one of peeling-off and lack of hiding was observed.

### (2) Oil Resistance

The resultant interior material article for an automobile was cut out into a test piece having a size of 50 mm×50 mm. The test piece was attached to a spacer ring having a diameter of 38 mm, and 1.5 g of liquid paraffin was dropped on the test piece in the spacer ring. Thereafter, this test piece having liquid paraffin was allowed to stand still at a temperature of 80° C. for 24 hours. The design surface of the skin layer (A) was then visually inspected. The results were judged in accordance with the following criteria, and shown in Table 2. The used liquid paraffin was a paraffin (trade name “FLUID PARAFFIN, LIGHT” manufactured by Nacalai Tesque, Inc.).

“Grade B”: creases and other abnormalities were not generated at all, or swallow irregularities along the grains were observed.

“Grade C”: creases different and distinguished from the grains were observed.

“Grade D”: deep crease trenches and/or caved creases were observed.

### (3) Humidity-Based-Ageing Resistance

The resultant interior material article for an automobile was allowed to stand still in a thermostat at a temperature of 50° C. and a relative humidity of 95% for 2,500 hours (humidity resistance acceleration test). Thereafter, the design surface was visually inspected to observe peeling-off in the design surface. Furthermore, the interior material article for an automobile after the test was cut out into a test piece having a size of 25 mm×150 mm. The base layer (C) thereof was fixed, and the laminated region of the skin layer (A) and the crosslinked foam layer (B) were chucked. Subsequently, the laminated region and the base layer (C) were peeled from each other to make an angle of 180 degrees therebetween at a rate of 30 mm/minute. In this way, a tensile test was made to measure the peel strength at the interface between the base layer (C) and the laminated region of the skin layer (A) and the crosslinked foam layer (B). Specifically, the base layer (C) and the crosslinked foam layer (B) were partially peeled from each other beforehand at the interface. The base layer (C) and the laminated region of the crosslinked foam layer (B) and the skin layer (A) were then pulled while they were peeled from each other to make an angle of 180 degrees therebetween to measure the peel strength at the interface. The results were judged in accordance with the following criteria, and shown in Table 2:

“◯”; no peeling-off was observed and the peel strength was 9.8 N or higher, and

“×”; peeling-off was observed or the peel strength was less than 9.8 N.

### (4) Appearance

The resultant interior material article for an automobile was cut out into a test piece having a size of 50 mm×50 mm. The design surface of the skin layer (A) of the test piece was then visually inspected. The results were judged in accordance with the following criteria, and shown in Table 2.

“◯”; no appearance defect was observed,

“Δ”; one to three of defects such as roughness and pinhole were observed, and

“×”; four or more defects such as roughness and pinhole were observed.

### (5) Cushioning Property

The resultant interior material article for an automobile was cut out into a test piece having a size of 50 mm×50 mm. Shore A hardness of design surface of the test piece was measured with a durometer according to JIS K 6253 (1993). The results were judged in accordance with the following criteria, and shown in Table 2.

“\textcircled{∘}”; Shore A hardness was less than 50,

“◯”; Shore A hardness was 50 or more and less than 70, and

“×”; Shore A hardness was 70 or more.

TABLE 2

| | | Interior material article for automobile | | | | | | | |
|---|---|---|---|---|---|---|---|---|---|
| | | Laminated sheet | | | | | | | |
| | | | Crosslinked | | Evaluation | | | | |
| | | Skin layer (A) | foam layer (B) | Base layer (C) | | Oil | Humidity-based- | | Cushioning |
| | | Forming material | Forming material | Forming material | Moldability | resistance | ageing resistance | Appearance | property |
| Example | 1 | A1 | B1 | C1 | ◯ | B | ◯ | ◯ | ⊚ |
| | 2 | A1 | B2 | C1 | ◯ | B | ◯ | ◯ | ◯ |
| | 3 | A1 | B1 | C2 | ◯ | B | ◯ | ◯ | ⊚ |
| | 4 | A1 | B1 | C3 | ◯ | B | ◯ | ◯ | ⊚ |
| | 5 | A1 | B6 | C1 | ◯ | C | ◯ | ◯ | ⊚ |
| | 6 | A1 | B7 | C1 | ◯ | C | ◯ | Δ | ◯ |
| | 7 | A1 | B8 | C1 | ◯ | B | ◯ | Δ | ◯ |
| Comparative | 1 | A1 | B3 * | C1 | X | D | X | Δ | X |
| Example | 2 | A1 | B4 * | C1 | — | — | — | — | — |
| | 3 | A1 | B5 * | C1 | X | C | ◯ | X | ◯ |

In Table 2, the symbols “*” each represent an item (material type) outside the scope or the range specified in the invention.

### 3. Advantageous Effects of Examples

Comparative Example 1 was an example in which a crosslinked foam layer (B3) formed by a crosslinking and foaming resin composition containing the polyolefin based resin (b2) of less than 65% by weight so as to be excessively small, and the polylactic acid-based resin (b1) of more than 30% by weight so as to be excessively large, was used. Sufficient moldability and humidity-based-ageing resistance were not obtained in Comparative Example 1.

Comparative Example 2 was an example in which a crosslinked foam layer (B4) formed by a crosslinking and foaming resin composition containing no modified polyolefin (b3) was used. The crosslinked foam layer (B) failed to be molded into a sheet form. Furthermore, the resultant molded body had large irregularities on the surface thereof so as to fail to be bonded to the skin layer (A).

In addition, Comparative Example 3 was an example in which a crosslinked foam layer (B5) formed by a crosslinking and foaming resin compostion containing the modified polyolefin (b3) of more than 10% by weight so as to be excessively large was used. The evaluation in the oil resistance test was at a level of grade C, wherein a sufficient oil resistance was not obtained. Additionally, a sufficient moldability was not obtained, either.

On the other hand, in Examples 1 to 4, wherein the essential requirements of the invention of the present invention were wholly satisfied, the moldability and the oil resistance were excellent. Furthermore, even after the humidity resistance acceleration test, the peel strength between the base layer (C) and the crosslinked foam layer (B) was high. Thus, it was understood that these interior material articles were hardly deteriorated.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. An interior material article for an automobile which comprises sequentially a skin layer (A), a crosslinked foam layer (B) and a base layer (C),
wherein said interior material article is composed of an integrated combination of a laminated sheet in which said skin layer (A) and said crosslinked foam layer (B) are joined and said base layer (C) by vacuum molding method,
wherein said skin layer (A) comprises a polyolefin-based resin (a1),
wherein said crosslinked foam layer (B) is a layer in which a crosslinking and foaming resin composition is crosslinked and foamed, said composition comprising a polylactic acid-based resin (b1), a polyolefin-based resin (b2) comprising a monomer unit based on ethylene and a monomer unit based on propylene, a modified polyolefin (b3) having an ester bond at its side chain, and a crosslinking aid (b4), and
wherein contents of said polylactic acid-based resin (b1), said polyolefin-based resin (b2) and said modified polyolefin (b3) in said crosslinking and foaming resin composition are respectively from 1% to 30% by weight, from 65% to 89% by weight and from 1% to 10% by weight based on 100% by weight of the total of said polylactic acid-based resin (b1), said polyolefin-based resin (b2) and said modified polyolefin (b3).

2. The interior material article for an automobile according to claim 1,
wherein said polyolefin-based resin (b2) comprises a polypropylene-based resin (b21) and a polyethylene-based resin (b22),
wherein said polypropylene-based resin (b21) is an ethylene-propylene copolymer containing a monomer unit based on ethylene in an amount of 25% or less by mole,
wherein said polyethylene-based resin (b22) is at least one of a polyethylene and a copolymer containing a monomer unit based on ethylene in an amount of 70% or more by mole, and
wherein the content of said polypropylene-based resin (b21) is 10% or more by weight based on 100% by weight of the total of said polypropylene-based resin (b21) and said polyethylene-based resin (b22) that are contained in said polyolefin-based resin (b2).

3. The interior material article for an automobile according to claim 1,
wherein said modified polyolefin (b3) is a copolymer of a monomer selected from the group consisting of a vinyl ester of a carboxylic acid and an ester of a (meth)acrylic acid, and an olefin.

4. The interior material article for an automobile according to claim 3,
wherein said polyolefin-based resin (b2) comprises a polypropylene-based resin (b21) and a polyethylene-based resin (b22),
wherein said polypropylene-based resin (b21) is an ethylene-propylene copolymer containing a monomer unit based on ethylene in an amount of 25% or less by mole,
wherein said polyethylene-based resin (b22) is at least one of a polyethylene and a copolymer containing a monomer unit based on ethylene in an amount of 70% or more by mole, and
wherein the content of said polypropylene-based resin (b21) is 10% or more by weight based on 100% by weight of the total of said polypropylene-based resin (b21) and said polyethylene-based resin (b22) that are contained in said polyolefin-based resin (b2).

5. The interior material article for an automobile according to claim 3,
wherein said base layer (C) comprises a polylactic acid-based resin and a natural fiber.

6. The interior material article for an automobile according to claim 3,
wherein said base layer (C) comprises a polyolefin-based resin and a natural fiber.

7. The interior material article for an automobile according to claim 3,
wherein said skin layer (A) has a concave-convex pattern by die forming.

8. The interior material article for an automobile according to claim 3,
wherein the ratio of a thickness t_{A} of said skin layer (A) to a thickness t_{B} of said crosslinked foam layer (B) is in the range from 0.05 to 1.0.

9. The interior material article for an automobile according to claim 4,
wherein said base layer (C) comprises a polylactic acid-based resin and a natural fiber.

10. The interior material article for an automobile according to claim 4,
wherein said base layer (C) comprises a polyolefin-based resin and a natural fiber.

11. The interior material article for an automobile according to claim 4,
wherein said skin layer (A) has a concave-convex pattern by die forming.

12. The interior material article for an automobile according to claim 4,
wherein the ratio of a thickness t_{A} of said skin layer (A) to a thickness t_{B} of said crosslinked foam layer (B) is in the range from 0.05 to 1.0.
